(19) United States
(12) Patent Application Publication
(10) Pub. No.: US 2017/0104796 A1
(43) Pub. Date: Apr. 13, 2017

(54) SYSTEM, METHOD AND APPARATUS FOR SIMULTANEOUS MEDIA COLLABORATION

(71) Applicant: Michael J. Fahey, Glastonbury, CT (US)

(72) Inventor: Michael J. Fahey, Glastonbury, CT (US)

(73) Assignee: ARMORED INFO, LLC, Hartford, CT (US)

(21) Appl. No.: 14/878,189

(22) Filed: Oct. 8, 2015

(51) Int. Cl. H04L 29/06; G06F 17/30

(52) U.S. Cl. CPC H04L 65/403; H04L 65/601; H04L 63/0428; G06F 17/30165; H04L 63/107

(57) ABSTRACT

A method, system, and apparatus for simultaneous media collaboration between remotely located users is disclosed. Unlike the existing collaboration methods currently used, which often include emailing files and comments back and forth between different users, the disclosed system and method enables real-time communication and collaboration between remotely located users without requiring the use of email or editing software.

### BACKGROUND OF THE INVENTION

Field of the Present Invention

The present invention relates generally to media collaboration, in particular, to a method, system, and apparatus for media collaboration between remotely located users in real time.

Background of the Related Art

Recording media is often a costly time-intensive process involving multiple parties. Conventionally, different parties (e.g., producer, audio engineer, vocalist, and video editor) would collaborate in a studio. However, with the increase in global collaboration and the cost and inconvenience of traveling, getting to a studio is increasingly difficult to do.

The arrival of recording software, such as a Digital Audio Workstation (DAW), has decreased the need for professional recording studios. This software can be implemented on a computer to allow artists to write, record, and edit files. Nonetheless, problems exist with such software. For example, it may not be possible to transfer files to all collaborators in real time due to bandwidth and/or latency limitations. Moreover, if a user is using recording software of a certain type, then the user can only communicate his or her recorded file with another user who has the same software. The problem is this software is both cumbersome and expensive. Even if the parties are using the same recording software, the parties are forced to communicate files and comments via email. However, this method of communicating is not always secure, as reflected in numerous incidents of unauthorized access to files prior to distribution. This method also prevents parties from collaborating and obtaining feedback in real time because parties often have to email files and comments back and forth. Thus, not only does this process require significant time investment, but it can stifle creativity.

In addition to the use of recording software, many studios send physical copies of files to known addresses of recipient. Like with communicating via email, this method is risky because it relies entirely on the recipient not disclosing the physical copy.

Further, online file storage and sharing services have an additional problem when dealing with uploaded files. Sometimes files are stored with no encryption on basic storage medium. The obvious problem with not encrypting files is that the files are vulnerable to unauthorized access because the content is readable if the storage medium is stolen or subject to duplication. Files can also be uploaded using a single encryption key. The problem with a single encryption key is that unauthorized users may gain access to the key. Once an unauthorized user has gained access to the single encryption key, all files become vulnerable in the same way as if the parties had stored the files with no encryption.

Based on the foregoing reasons, it is readily apparent that there is a need for a system, method and apparatus for simultaneous media collaboration that is secure.

### Objects of the Present Invention

The main object of the present invention is to provide a system, method and apparatus that enables real time media collaboration between remotely located users that is efficient and cost effective.

Another object of the present invention is to provide a method and system that provides protection against unauthorized copying and distribution of collaborated media files.

### SUMMARY OF THE INVENTION

The present invention includes a system, method and apparatus that enables real time collaboration between remotely located users on a secure environment.

In a first embodiment, the present invention includes a system for real time media collaboration between at least two users operating the same electronically connected software application in remote locations, the system including at least one secure database running the software application, the at least one secure database interconnected to a network having access to a public or private internet connection, the software application including a first set of instructions to provide access to a media file simultaneously to each of at least two users, such that one user of the at least two users may modify the media file in a real time collaborative environment simultaneously with the other user of the at least two users; a graphical user interface (GUI) displaying the application where the GUI is interconnected to the at least one secure database where the media file is stored on a real time basis as each of the at least two users modify the media file simultaneously; and application having simultaneous accessibility for the at least two users where each of the at least two users may manipulate the media file in real time and in a secure manner.

In some embodiments the system includes security module structured and arranged to determine the location of each of at least two users in order to selectively restrict access to the media file based upon the location.

In some embodiments the system includes a content delivery network module interconnected to the GUI and the secure database and being the structured and arranged for receipt and storage of the media file received from multiple application software access points.

In some embodiments the system includes an encryption module interconnected to the database and the GUI, the encryption module structured and arranged to provide secure point to point encryption between the at least two users.

In some embodiments the system includes a synchronization application module interconnected to the GUI and the least one secure database, the synchronization application module structured and arranged to synchronize modifications of the file.

In some embodiments the system includes media files that are pre-recorded audio signals.

In some embodiments the system includes media files that are pre-recorded video signals.

In some embodiments the system includes a security module having a global position system.

In a second aspect the present invention includes a computer apparatus consisting of a computer storage medium, a database, a central processor and a gui all electrically interconnected, where the computer storage medium contains computer software having instructions to provide access to a media file simultaneously to each of at least two users, such that one user of the at least two users may modify the media file in a real time collaborative environment simultaneously with the other user of the at least two users; display the application to each user, where the GUI is interconnected to the at least one secure database where the media file is stored on a real time basis as each of the at least two users modify the media file simultaneously; and provide simultaneous access to the application such that each of the at least two may manipulate the media file in real time and in a secure manner.

In some embodiments the apparatus includes instructions to determine the location of each of at least two users in order to selectively restrict access to the media file based upon the location.

In some embodiments the apparatus includes instructions to for receipt and storage of the media file received from multiple application software access points.

In some embodiments the apparatus includes instructions to provide secure point to point encryption between the at least two users.

In some embodiments the apparatus includes instructions to provide instructions to synchronize modifications of the file.

In some embodiments the apparatus includes to media files having pre-recorded audio signals.

In some embodiments the apparatus includes media files having pre-recorded video signals.

In some embodiments the apparatus includes instructions to implement a global position system.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a schematic illustration of an exemplary computing environment, which is applicable to implement embodiments of the present invention;

FIG. 2 is a schematic illustration of the process flow of the graphical user interface according to one embodiment of the present invention;

FIG. 3A is a schematic illustration of a graphical user interface according to one embodiment of the present invention;

FIG. 3B is a schematic illustration of a graphical user interface prompting for user input according to one embodiment of the present invention;

FIG. 4 is a schematic illustration of simultaneous audio collaboration between two remotely located users according to one embodiment of the present invention;

FIG. 5A is a schematic illustration of a project library that allows user interaction according to one embodiment of the present invention;

FIG. 5B is a schematic illustration of a map and geofence that allows user interaction according to one embodiment of the present invention;

FIG. 5C is a schematic illustration of a graphical user interface illustrating prompting for user input regarding geofence restriction according to one embodiment of the present invention;

FIG. 6 is a schematic illustration of point to point encryption between two remotely located users according to one embodiment of the present invention;

FIG. 7A is a schematic illustration of a graphical user interface prompting for user input for login according to one embodiment of the present invention;

FIG. 7B is a schematic illustration of a graphical user interface managing account security according to one embodiment of the present invention;

FIG. 7C is a schematic illustration of a graphical user interface displaying the synchronization (“sync”) history application module according to one embodiment of the present invention;

FIG. 7D is a schematic illustration of file names and folders that is an exemplary view of the folders in the encryption folder according to one embodiment of the present invention;

FIG. 7E is a schematic illustration of file names and accompanying information that is an exemplary view of the folders in the encryption folder according to one embodiment of the present invention;

FIG. 7F is a schematic illustration of the icon that is displayed in the lower right corner of a folder when a folder or file is being synced according to one embodiment of the present invention;

FIG. 7G is a schematic illustration of file names and accompanying information that is an exemplary view of the folders in the encryption folder according to one embodiment of the present invention;

FIG. 7H is a schematic illustration of a graphical user interface displaying the sync history and sync logo according to one embodiment of the present invention;

FIG. 7I is a schematic illustration of a graphical user interface displaying the account history according to one embodiment of the present invention;

FIG. 7J is a schematic illustration of the encrypted folder according to one embodiment of the present invention;

FIG. 7K is a schematic illustration of a graphical user interface prompting for user input according to one embodiment of the present invention;

FIG. 7L is a schematic illustration of a graphical user interface prompting for user input according to one embodiment of the present invention;

FIG. 7M is a schematic illustration of a graphical user interface prompting for user input according to one embodiment of the present invention;

FIG. 7N is a schematic illustration of a graphical user interface prompting for user input according to one embodiment of the present invention;

FIG. 7O is a schematic illustration of a graphical user interface prompting for user input according to one embodiment of the present invention;

FIG. 7P is a schematic illustration of a graphical user interface prompting for user input according to one embodiment of the present invention;

FIG. 7Q is a schematic illustration of a graphical user interface prompting for user input according to one embodiment of the present invention;

FIG. 7R is a schematic illustration of a graphical user interface prompting for user input according to one embodiment of the present invention;

FIG. 7S is a schematic illustration of a graphical user interface prompting for user input according to one embodiment of the present invention;

FIG. 8A is a schematic illustration of simultaneous video collaboration between two remotely located users according to one embodiment of the present invention; and

FIG. 8B is a schematic illustration of a graphical user interface according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

Exemplary Operating Environment

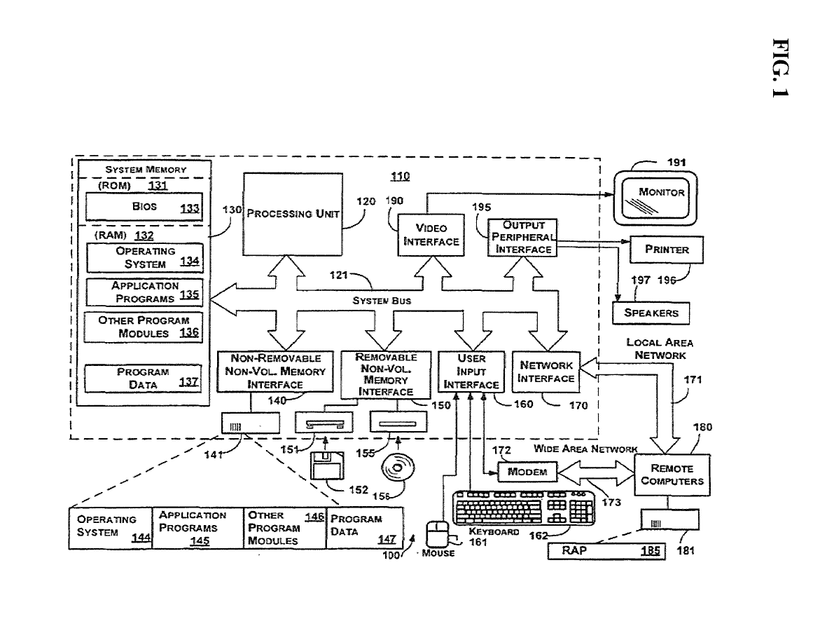

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

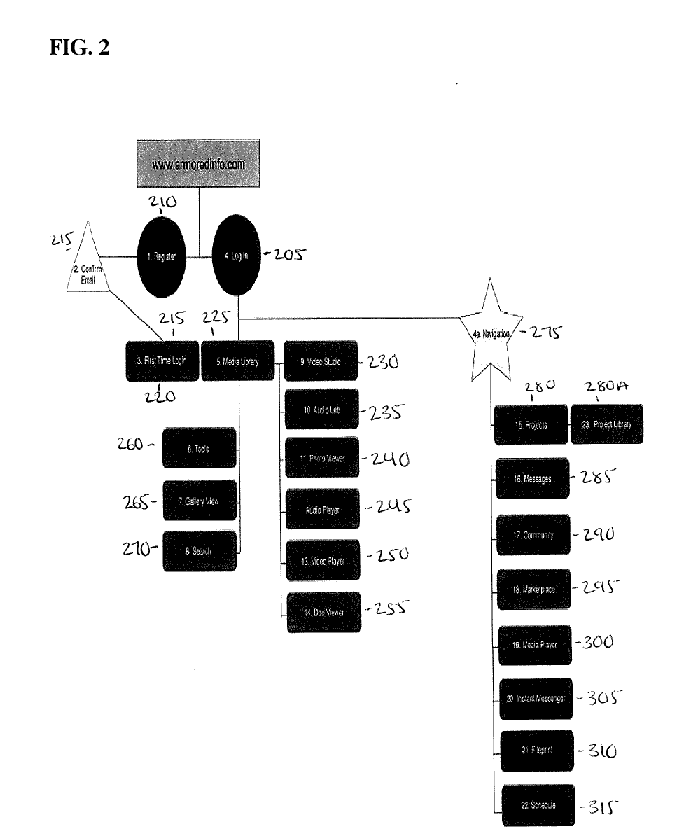

Referring now to FIG. 2, there is shown a schematic illustration of the process flow of the graphical user interface. Upon accessing the home page screen, the user is prompted to enter log-in information (e.g., username and password or other identifying information) 205. If a prospective user does not have an account but wishes to create one, the user may do so by selecting to register 210 and entering account information (e.g., first name, last name, email address, username, and password). After confirming the email address 215, the user will be able to log in for the first time 220. Upon logging in, the user is able to access the home page screen (described below), along with the user's media library 225, which is where all the user's audio files reside. After accessing the media library 225, the user is given various options, including accessing the video studio 230, the audio lab 235, the photo viewer 240, the audio player 245, the video player 250, and the doc reviewer 255. From the media library 225, the user can also access different tools 260, access the gallery view 265, and search 270. In addition. the user can perform various tasks 275, including viewing the user's projects 280, the project library 280A, viewing and sending messages 285, the community 290, the marketplace 295, the media player 300, instant messenger 305, file print 310, and schedule 315.

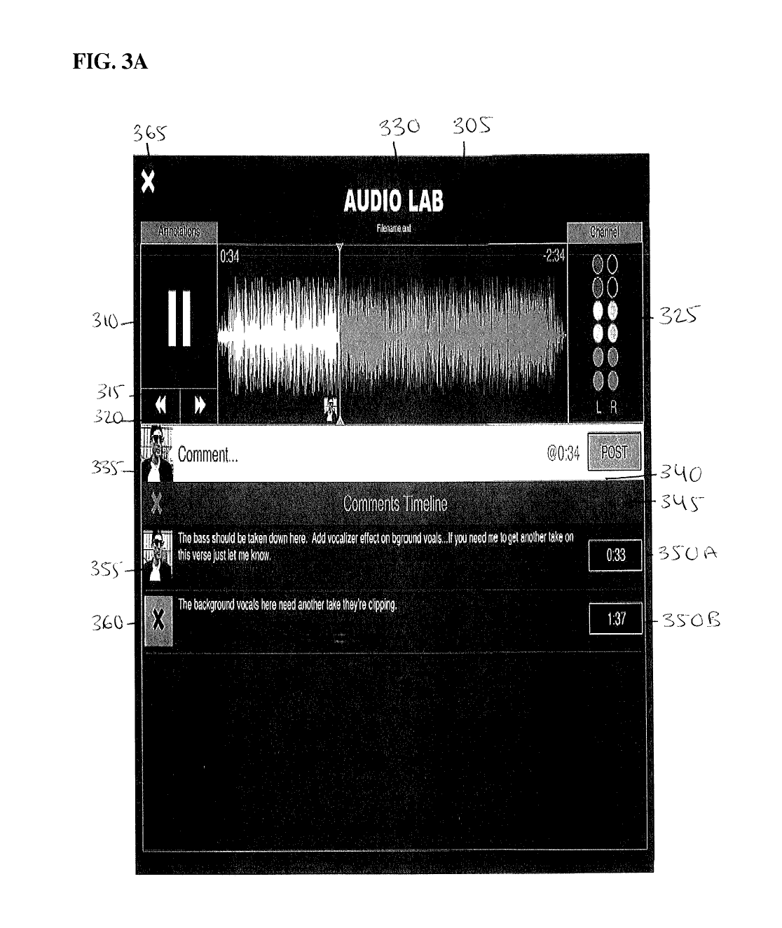

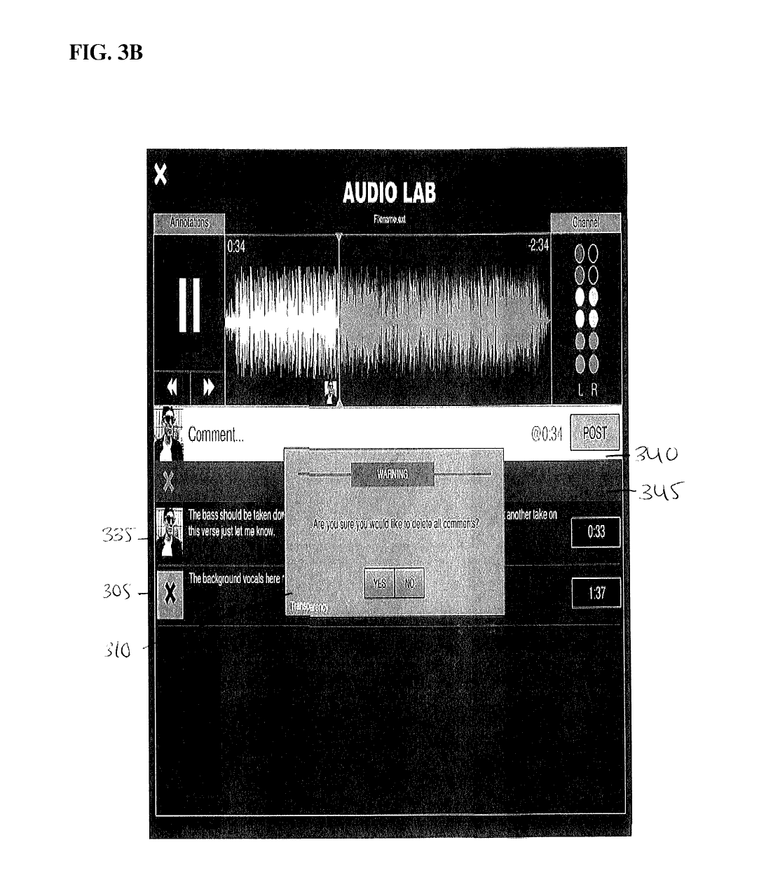

Referring now to FIG. 3A, there is shown a schematic illustration of a graphical user interface 300, which is the view the user sees when they click on the Audio Lab icon in list view. The graphical user interface 300 displays a waveform 305 of the audio file the user is working on. The graphical user interface 300 provides basic playback functions such as play/pause 310, rewind 315 (will rewind five seconds), fast forward 320 (will fast forward five seconds), and increase or decrease playback volume of different channels 325. Alternatively, the user may access any point of time within the audio file with the use of a slider 330. By dragging the slider 330 to a desired location along the waveform display 305, the user is thereby able to access the recording at that fragment of the audio file. The user can also highlight a section of the slider 330 to loop that particular section of the audio file. The waveform 305 may provide visual clues to assist the user when selecting a starting point within the audio file. Further, a photo of the user 335 will provide visual clue to assist the user in identifying the author of a specific comment. In addition to these basic playback functions, the user can submit comments about portions of the audio file 340.

The comments are stored and displayed in the comments timeline 345 and are given a timestamp 350(a) and 350(b). The comments are displayed in real time. A timestamp is any data identifying the time within the audio file in which the comment was submitted by the user. For any given audio file, there may be a large number of comments containing timestamps. Some of these timestamps will refer to a common fragment of the audio file even though the timestamps may be different. For example, timestamps may refer to the same fragment of the audio file given that the sound in the audio file can occur over several seconds, and different users may focus on different fragments when submitting their comments. In addition, multiple comments may be displayed on the timeline by different users who are part of a project. In the example shown, a user inputs a comment that “The bass should be taken down here. Add vocalizer effect on background vocals . . . If you need me to get another taken on this verse just let me know” 355. In the other example shown, another user inputs a comment that “The background vocals here need another take they're clipping” 360. After a user has finished using the audio lab, a user may exit the program by hovering over the X button 365. An email is sent to contributors notifying them when comments are added and then audio lab is closed.

Referring now to FIG. 3B, there is shown a schematic illustration of a graphical user interface prompting for user input. In the exemplary shown, all of the comments displayed in the timeline 340 may be deleted. The user may delete all comments by hovering over a user's profile picture 335 in the comments timeline 340, which will cause an X to appear 305. Upon selecting the X, a dialogue box will appear 310 prompting the user to select whether or not to delete all comments, and deleting all comments based on the selection by the user in response to the dialogue box.

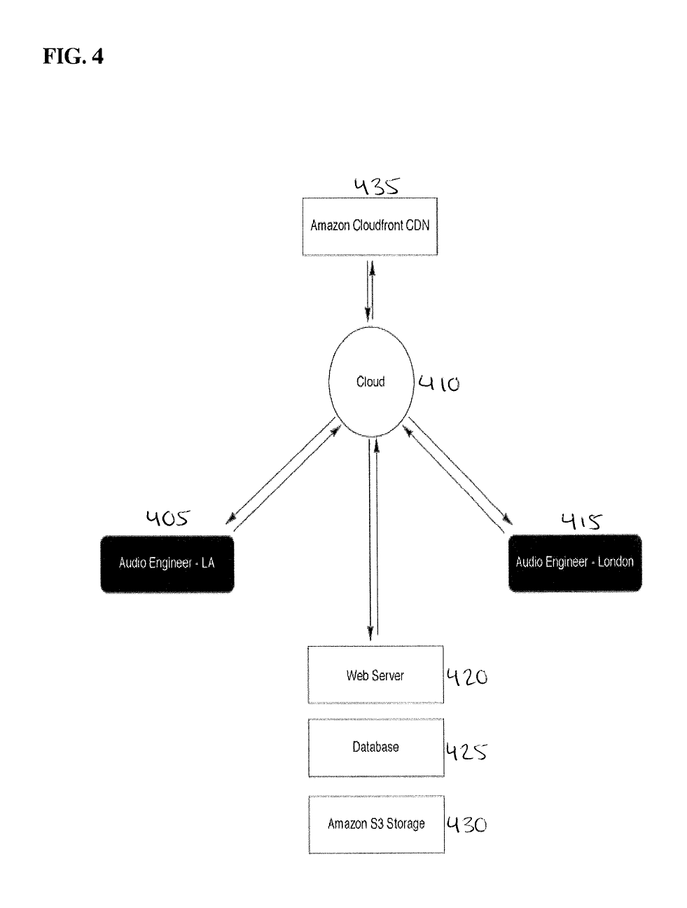

Referring now to FIG. 4 there is shown a schematic illustration of simultaneous audio collaboration. In the exemplary shown, a user, an audio engineer in Los Angeles 405, uploads an audio file to the cloud 410 and is able to simultaneously collaborate with an audio engineer in London 415. Collaboration is real time and both contributors have access to the same audio file. This is possible because collaboration is happening through the web server 420, not locally on a user's device. After being transferred to the web server 420, the audio file is then transferred to the database 425 and then a storage devices such as an Amazon S3 Storage 430. The audio engineer in London 415 is able to make changes and provide comments to the same audio file. This real-time collaboration occurs without either party traveling, emailing, or requiring the same audio recording software. For example, this can all be done without the user having to repeatedly download the audio file locally, open it in a DAW such as ProTools/Logic, make revisions, create a new bounce, and re-upload it to an unsecure cloud storage service or send a copy via email.

The third-party content delivery network, e.g. Amazon's CloudFront CDN 435, is configured for receipt and storage of content received from multiple devices. In addition, the content delivery network is configured to be accessible by one or more viewer computing devices as required.

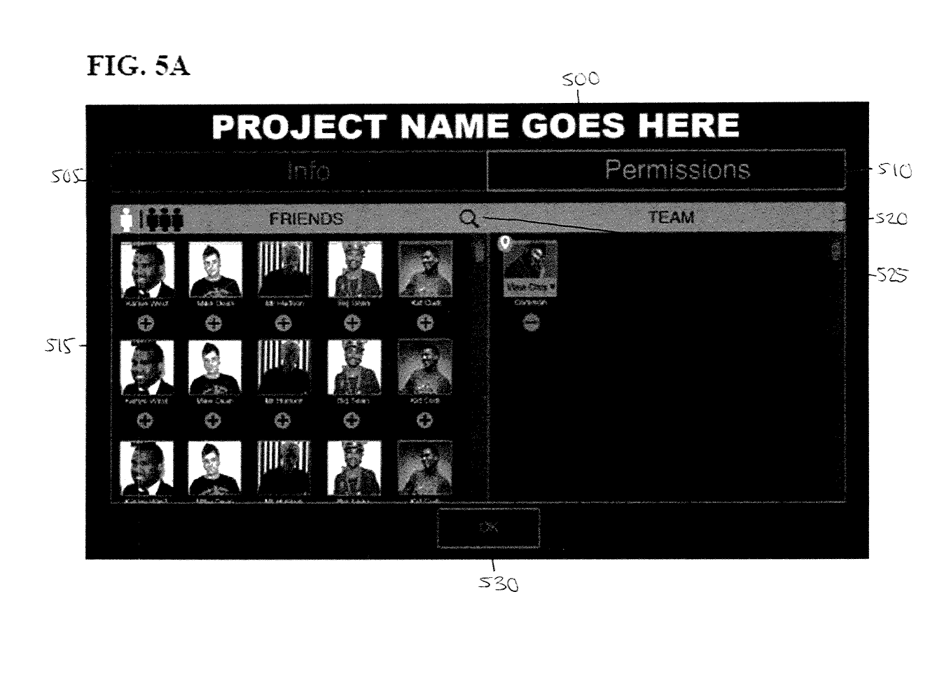

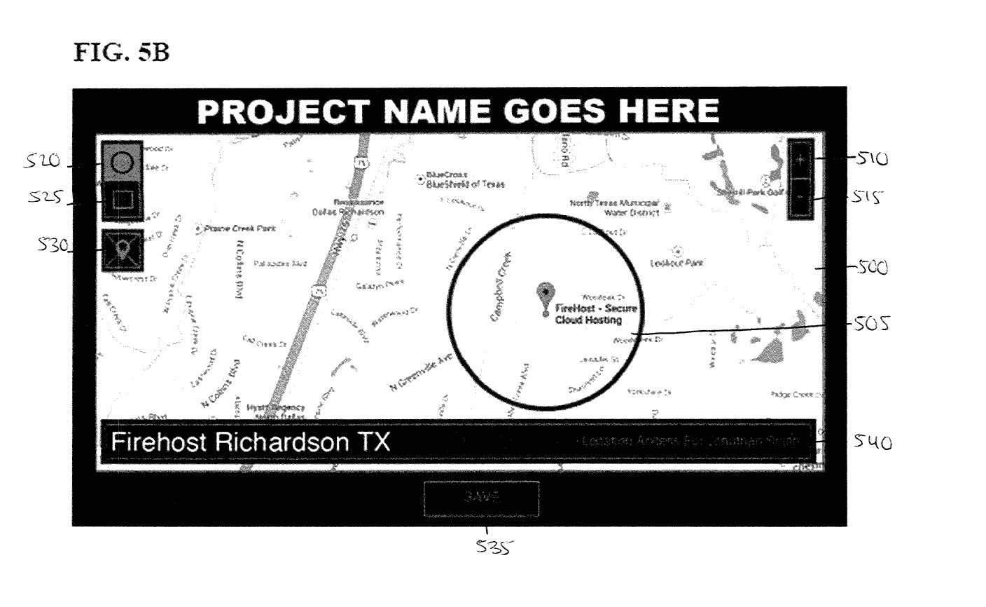

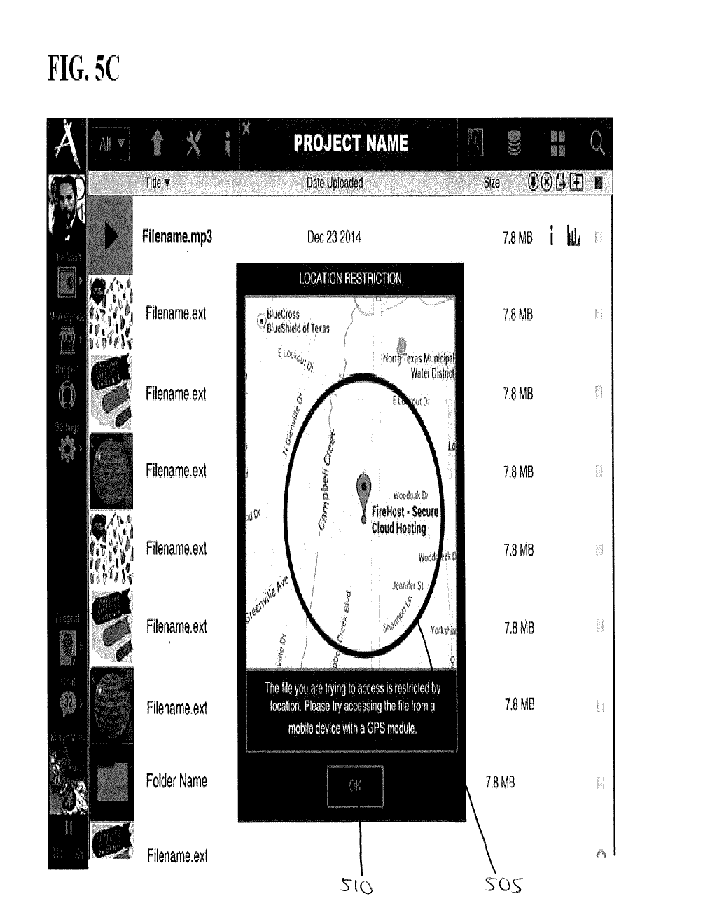

Referring now to FIG. 5A, there is shown a schematic illustration of a project library that allows user interaction. In the exemplary shown, the user is able to view the name of the uploaded project 500. When users select info 505, they will be able to view the permissions tab 510. Users will then be able to add user account friends 515 to the team 520 for each project and control their access level by clicking the drop down menu. Users can also search 525 by friend names. In the example shown, the user has been given view-only access to the team member. Different access levels are available. For example, users will select from read-only, modify, download, and admin. Read only allows users to play/view the file. If a user has read-only access, a watermark will be applied to the audio file to ensure it remains protected. Modify allows a user to play/view the file and modify its contents while in the system. Download allows a user to play/view the file, modify its contents while in the system, and download the file to local storage. Admin allows a user to play/view the file, modify its contents while in the system, download the file to local storage, and change project info and permissions. If a user wants to save the selections made, the user may do so by selecting the OK button 530.

Referring now to FIG. 5B, there is shown a schematic illustration of an example map 500 and a geofence 505. The map 500 is visible to a user when they select to restrict the user's audio file access to a certain location. In the example shown, the geofence 505 on the map indicates that the geofence surrounds “FireHost—Secure Cloud Hosting.” Users can zoom in 510 and zoom out 515 of the map. In addition, users can pinch out (zoom in) on the map and pinch in (zoom out) on the map. Users can also change the display of the map by scrolling up or down with a mouse or trackpad. Scrolling up will zoom in on the map and scrolling down will zoom out on the map. Once a user has access to the map, the user is able to select the circle trace button 520, which allows a user to trace a location with a circle. Trace works like a Photoshop circle. Selecting the square trace button 525 allows a user to trace a location with a square. Trace works like Photoshop square. If a user wants to clear a trace on the map, the user may do so by selecting remove trace 530. However, if a user wants to save the trace on the map and restrict user file access only within the geofence, the user may do so by selecting to save the location information 535. Users are notified if the file has location access and what the location is 540. Moreover, the project name at the top of the map 550 notifies users of the project associated with the location access restriction. Users must be on a GPS enabled device to access this one embodiment of the present invention.

Referring now to FIG. 5C, there is shown a schematic illustration of a graphical user interface prompting for user input regarding location restriction. In the exemplary shown, a user receives this notification when a user tries to access the audio files from a project that has a location restriction for that particular user 505. The user will be asked to access the file from a mobile device with a GPS module. Selecting OK 510 will close the dialog box.

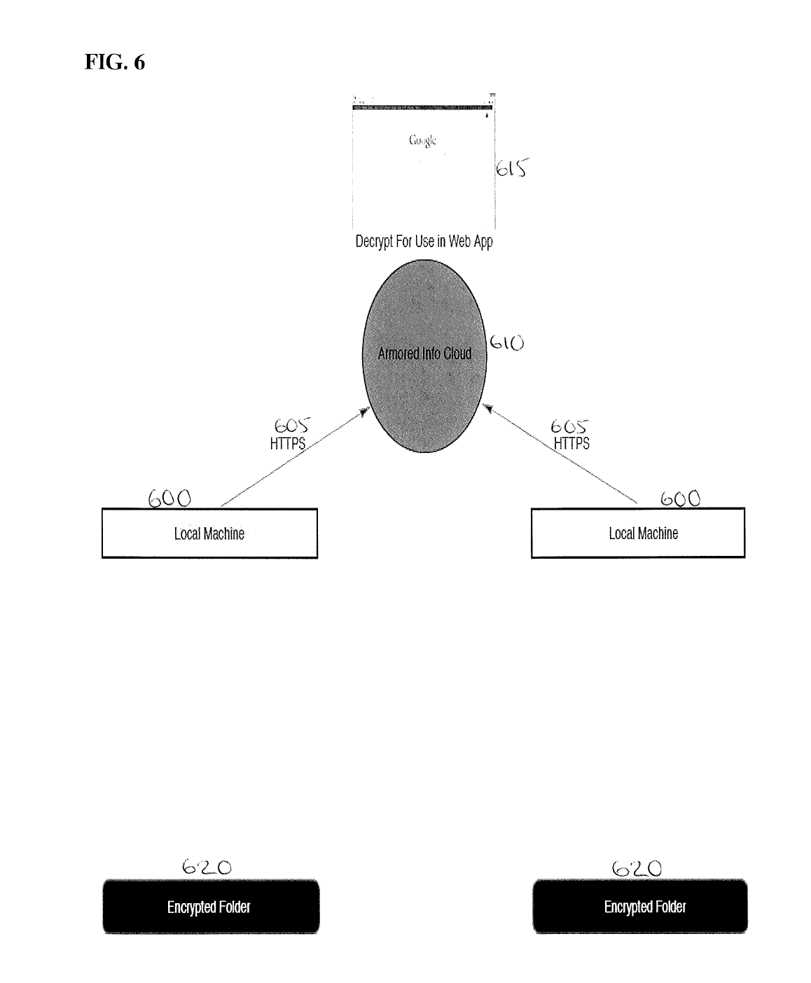

Referring now to FIG. 6, there is shown a schematic illustration of point to point encryption between two remotely located users. Each piece of content on the local machine 600 that is uploaded to the server via an encryption module 605 and sent directly to a cloud storage module 610. Thus, this allows for point to point encryption. The content is then decrypted for use in the web application 615.

Each piece of content uploaded to the server is encrypted with a newly generated key and saved in an encrypted folder 620. This is referred to as the item key. The item key is stored in encrypted form. The item key is encrypted using the user's public key. The encrypted item key is stored in a database in order to associate it with an encrypted file.

The server may provide a mechanism for the user to download and backup their files in unencrypted form by removing the files from the encrypted folder. The request to download or move the encrypted file must be accompanied by the user secret password in order to allow the server to decrypt the encrypted file, so the encrypted file can only be backed up by a user who is in possession of their user secret password. If a user attempts to download a file to which they have not been granted access, they will have no way to obtain a correctly decrypted copy of the file, and therefore no way to access the file. This restriction applies independently to any code on the server which checks for permissions for a user to access a file.

The user should store the password securely. If a user who has forgotten their password or otherwise lost their user password, the server may offer a mechanism for the user to change their password. The server must also validate the identity of the uploading user in some other manner to ensure that the reset of the password is not being carried out by an unauthorized user. Provided the user is authenticated properly and the correct password is uploaded, the server can encrypt the user password using the new user password and then store this new password in the database. The new user password will allow the user access to all of their existing files.

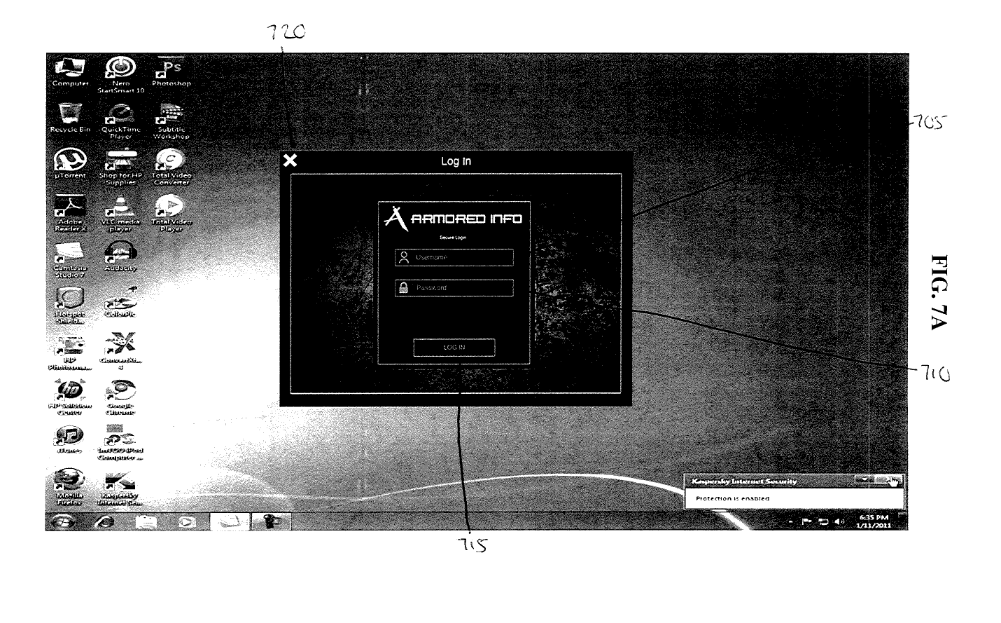

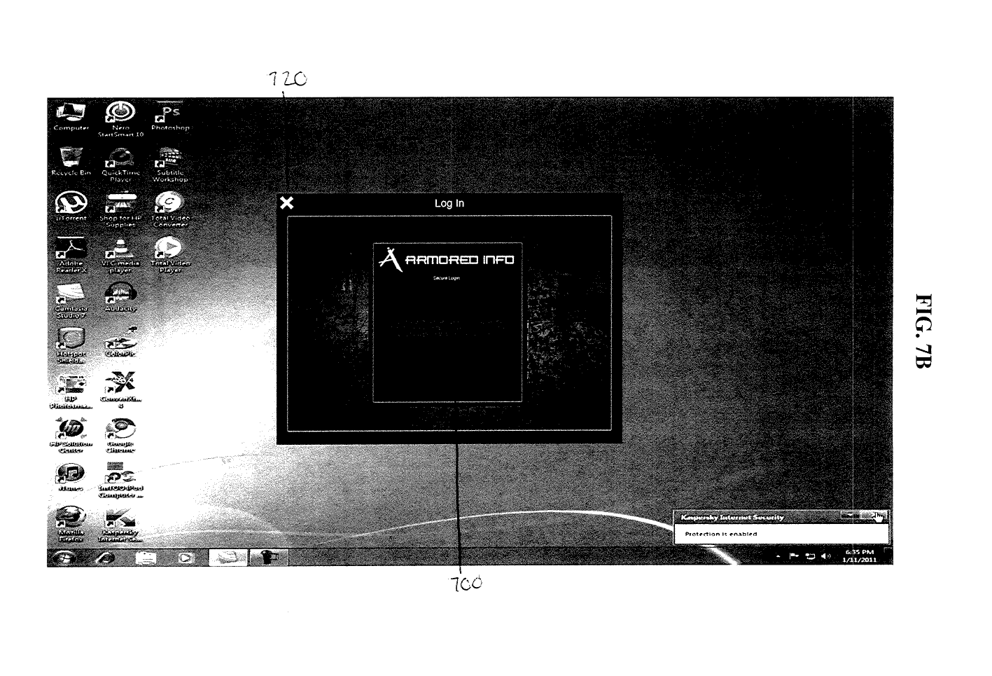

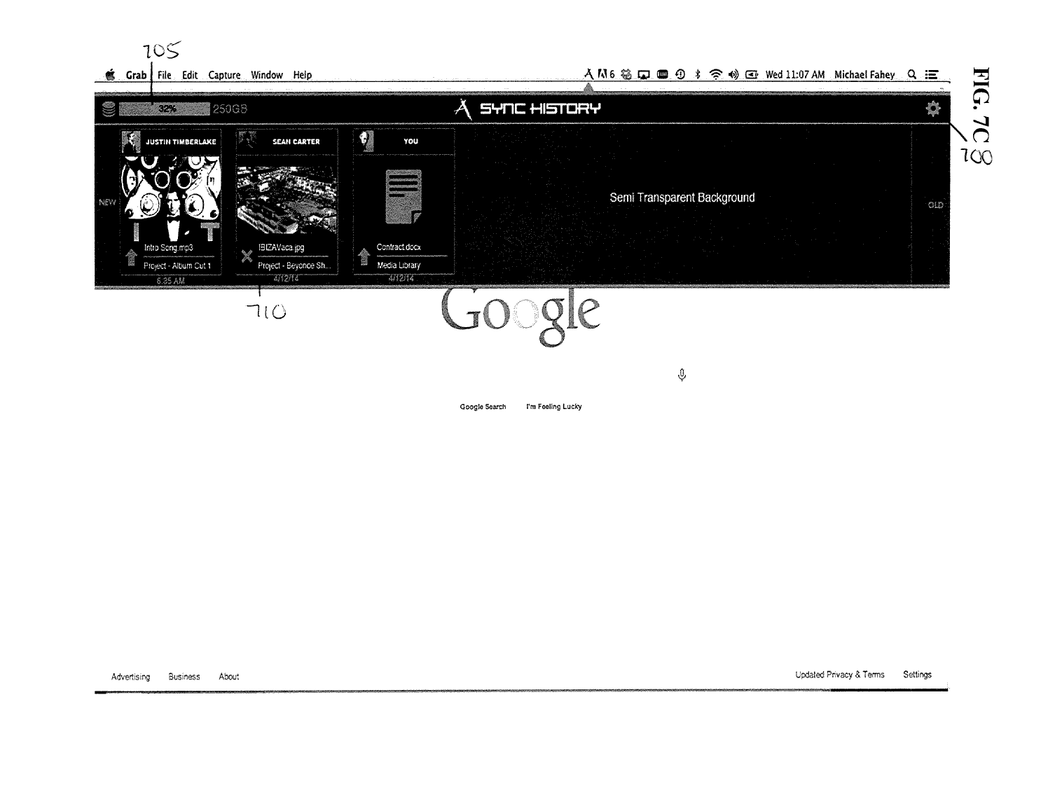

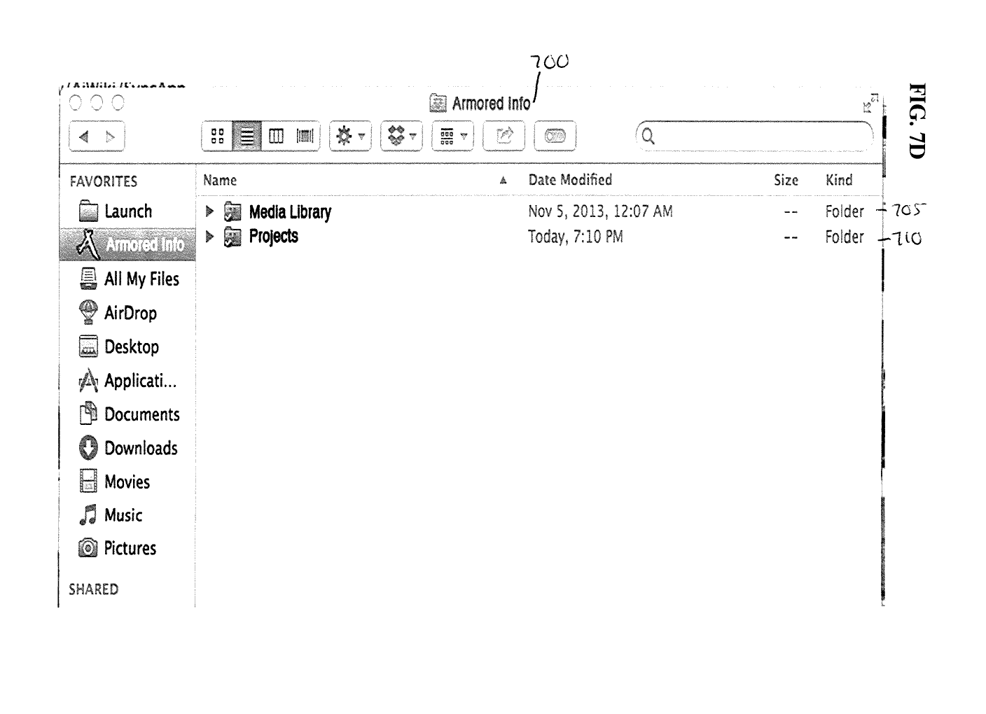

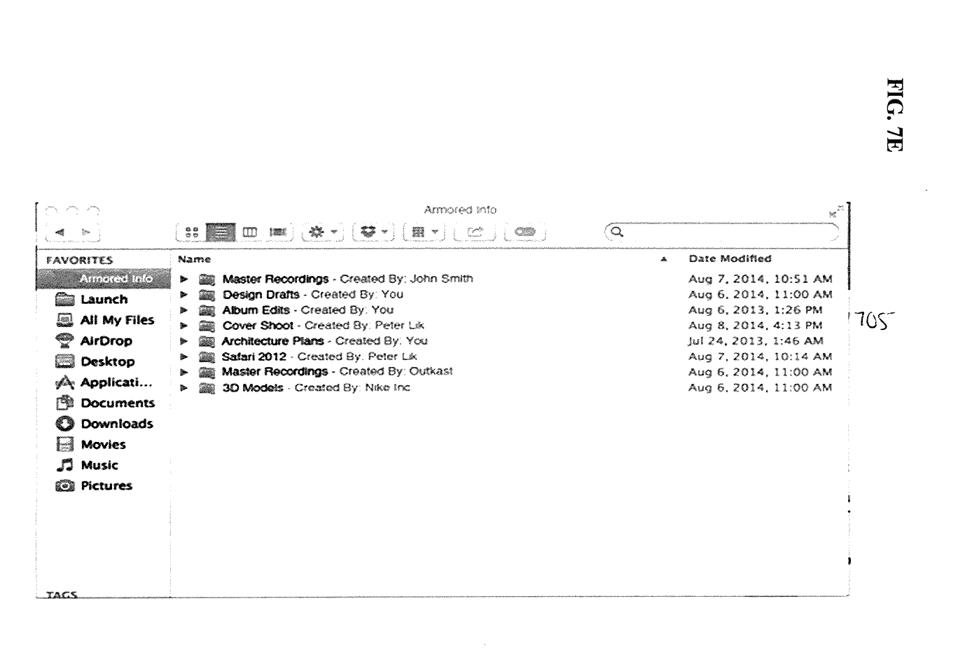

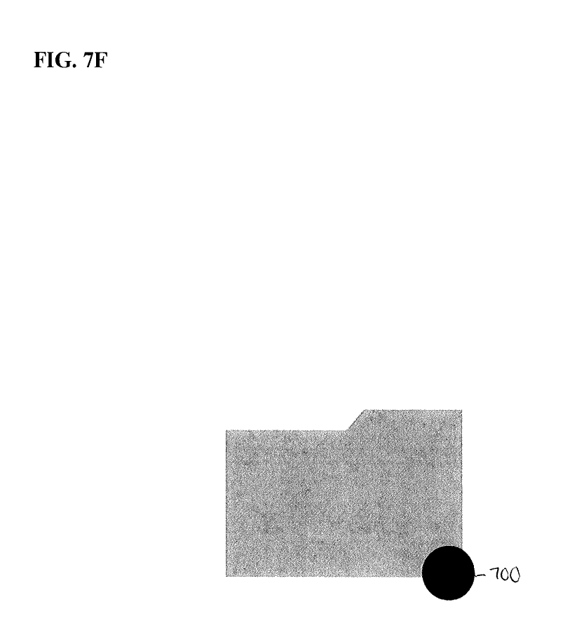

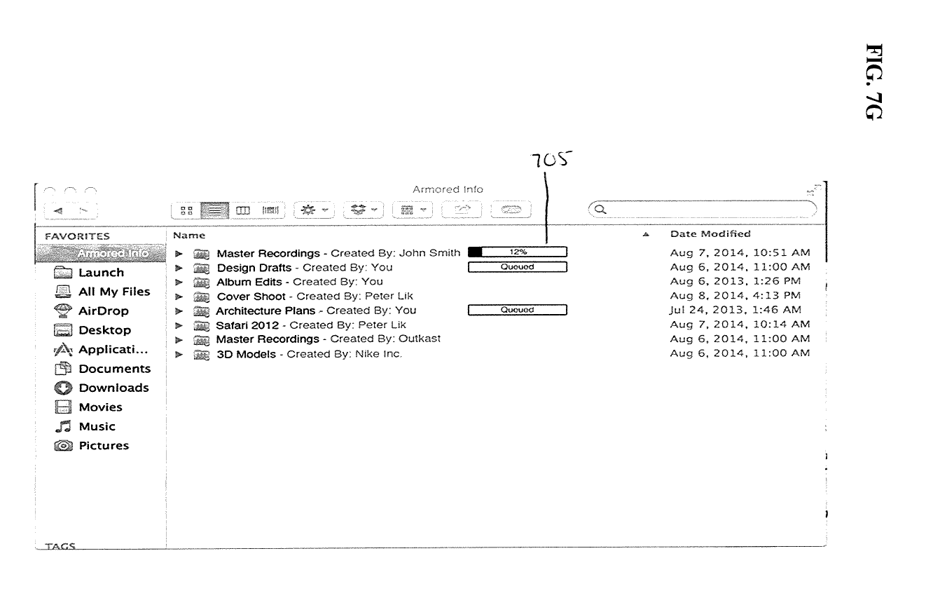

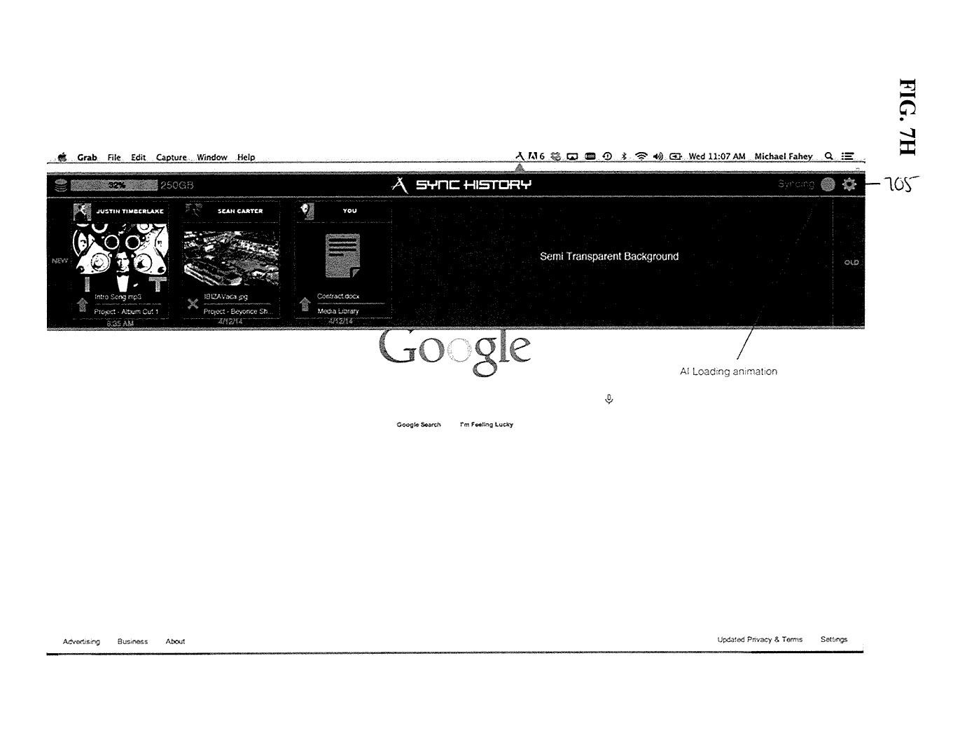

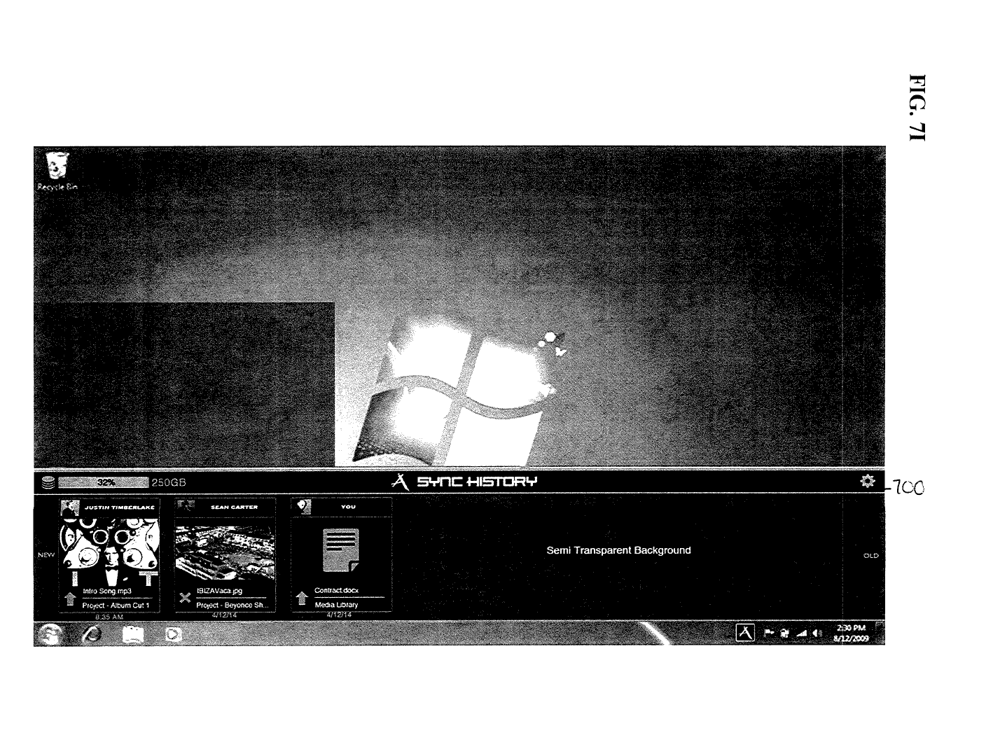

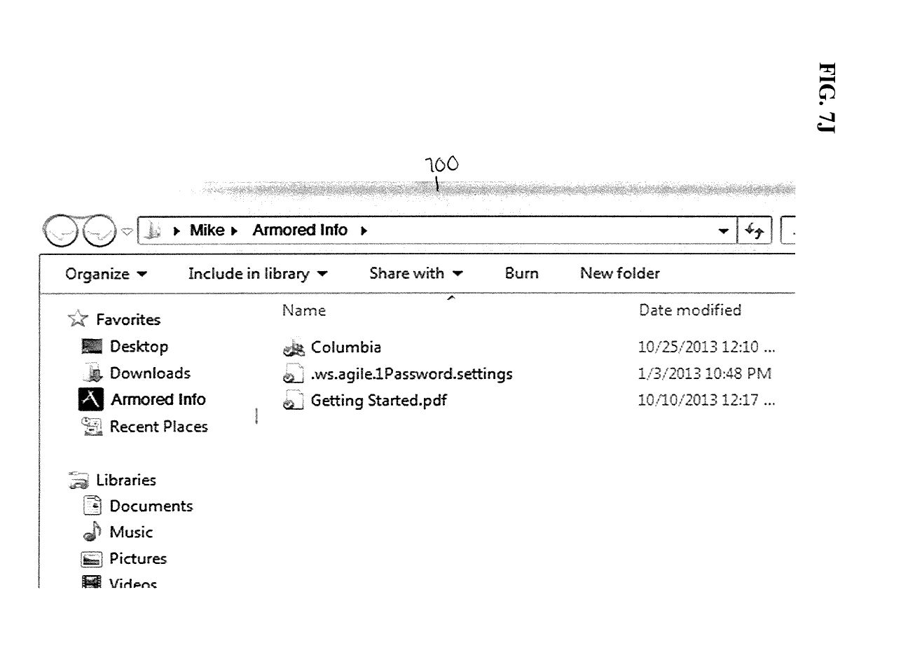

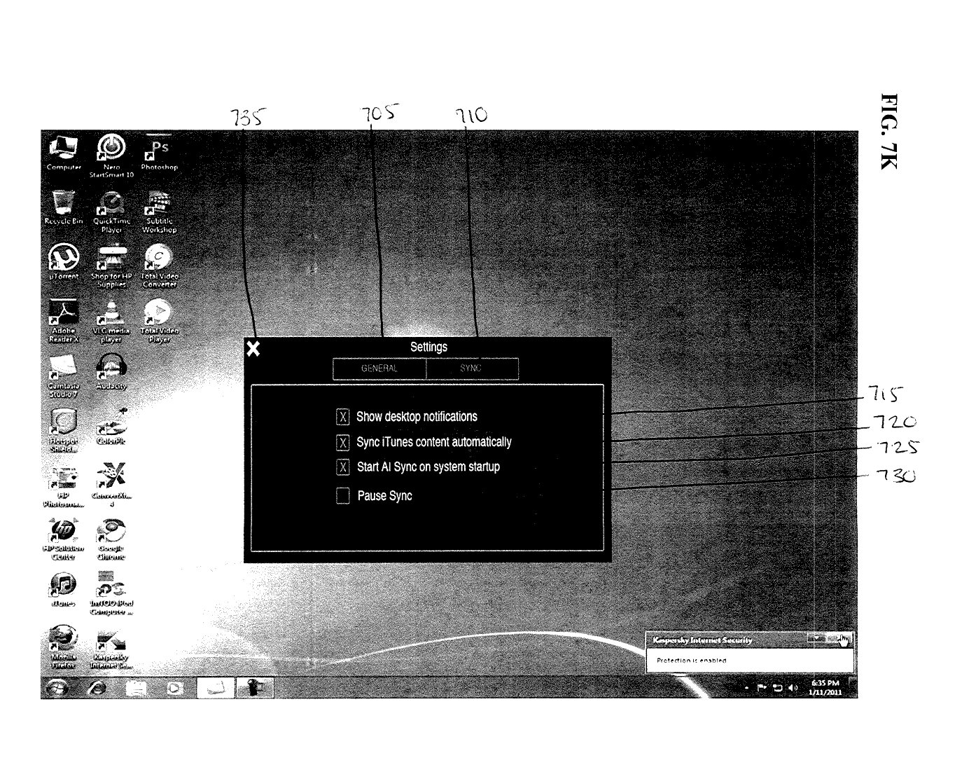

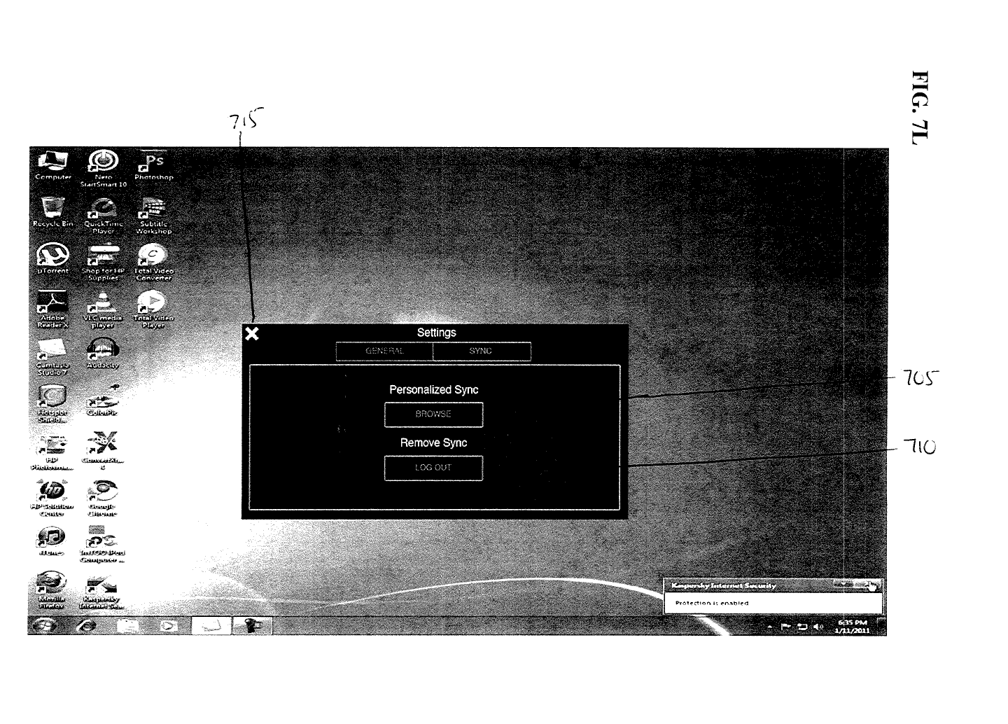

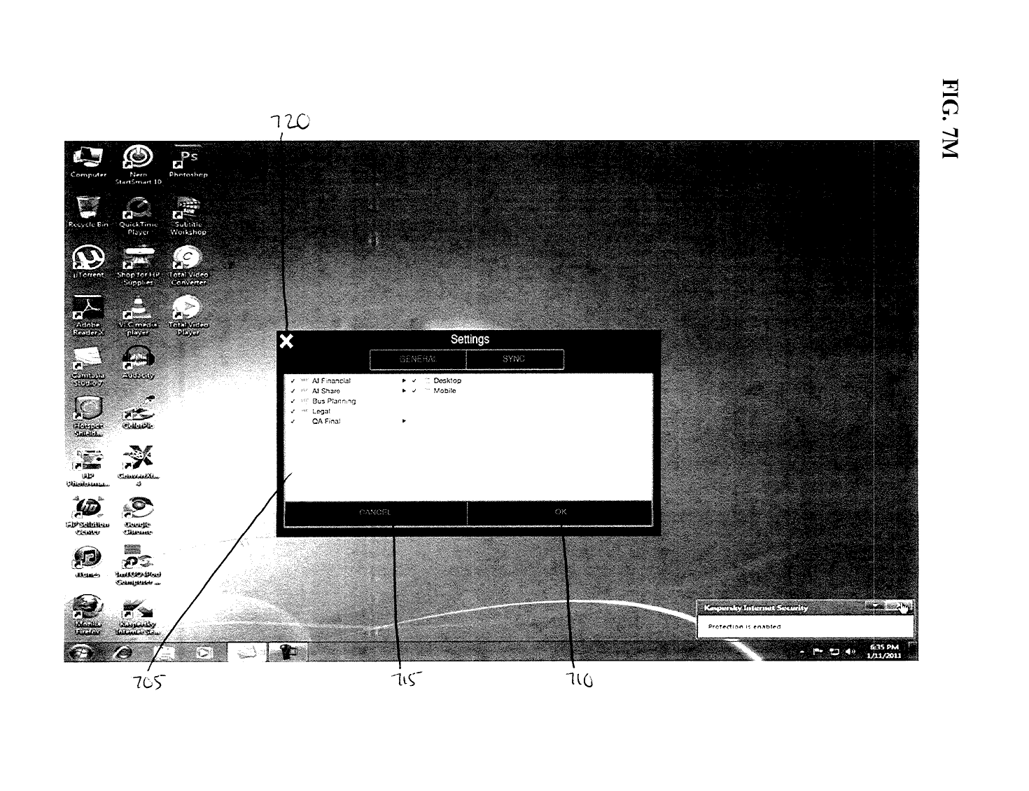

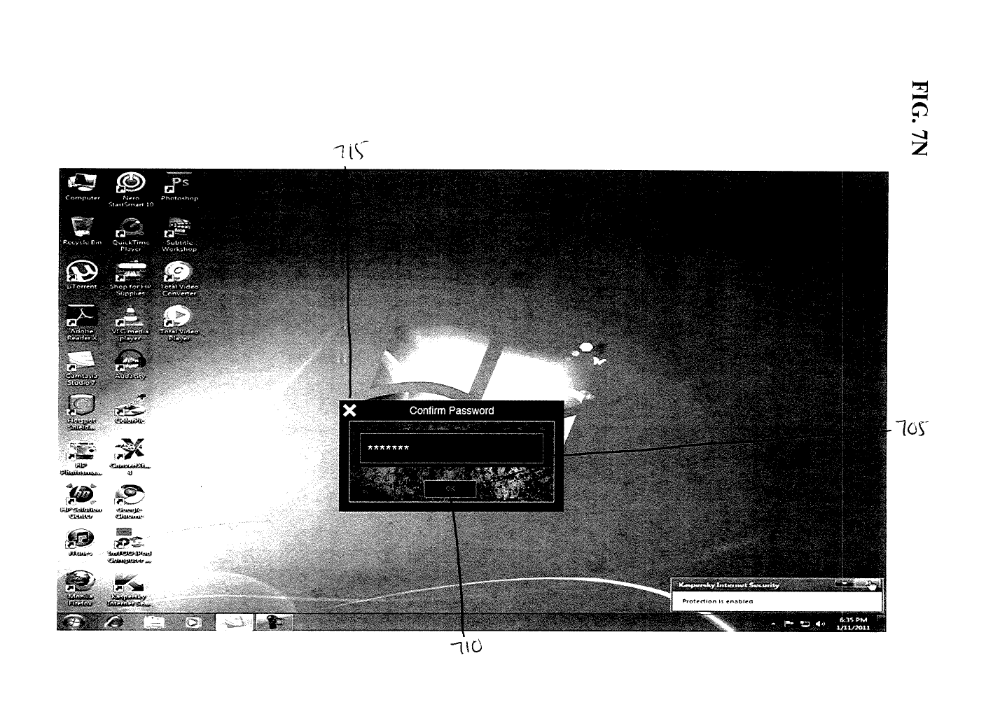

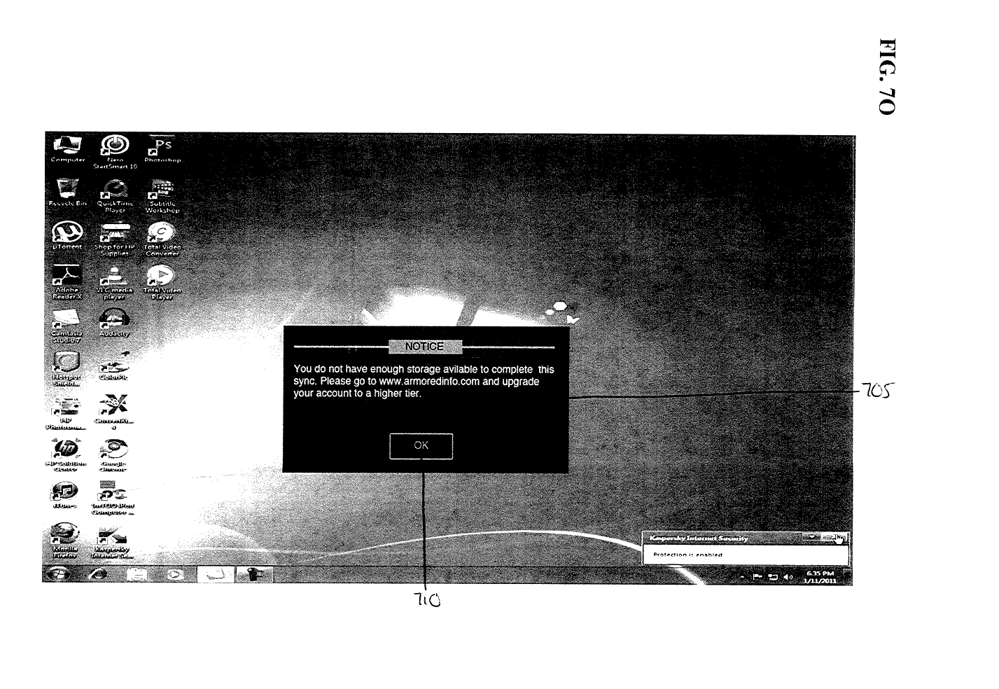

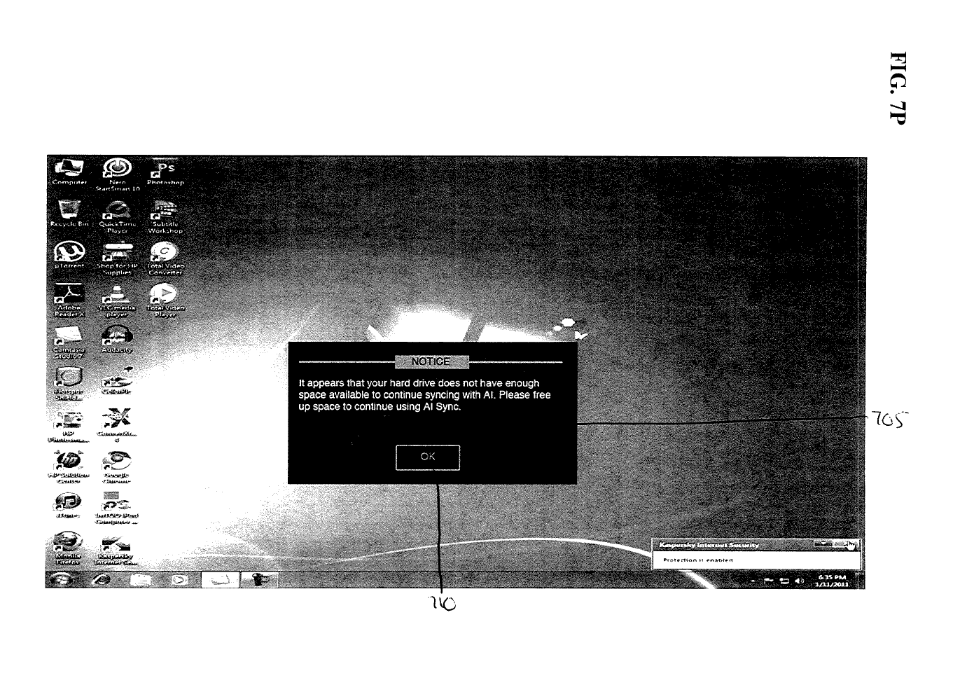

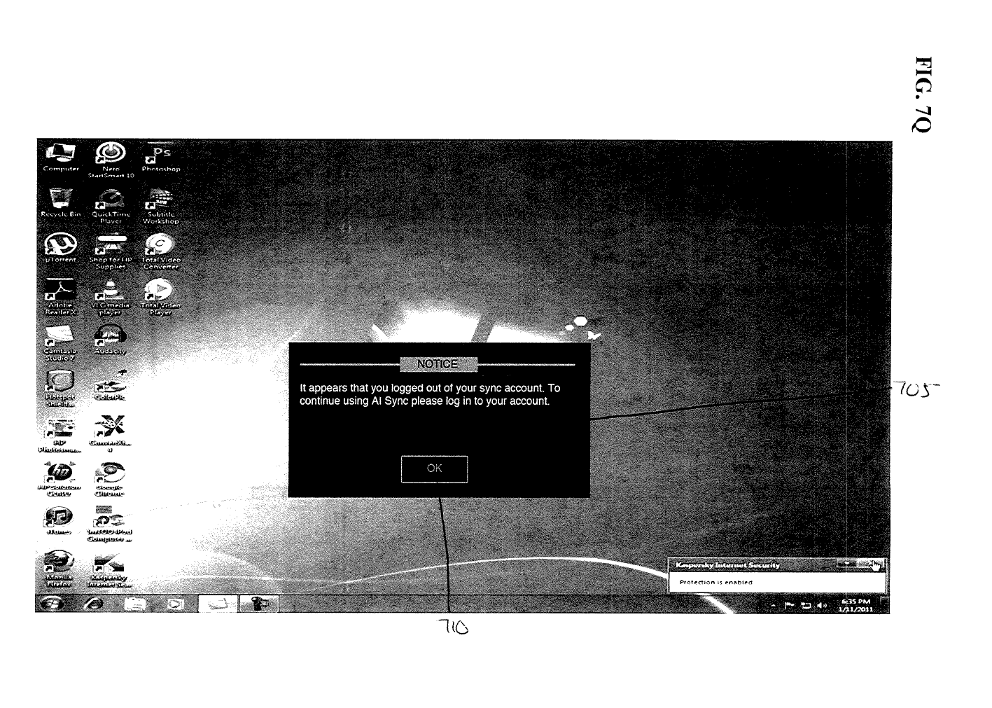

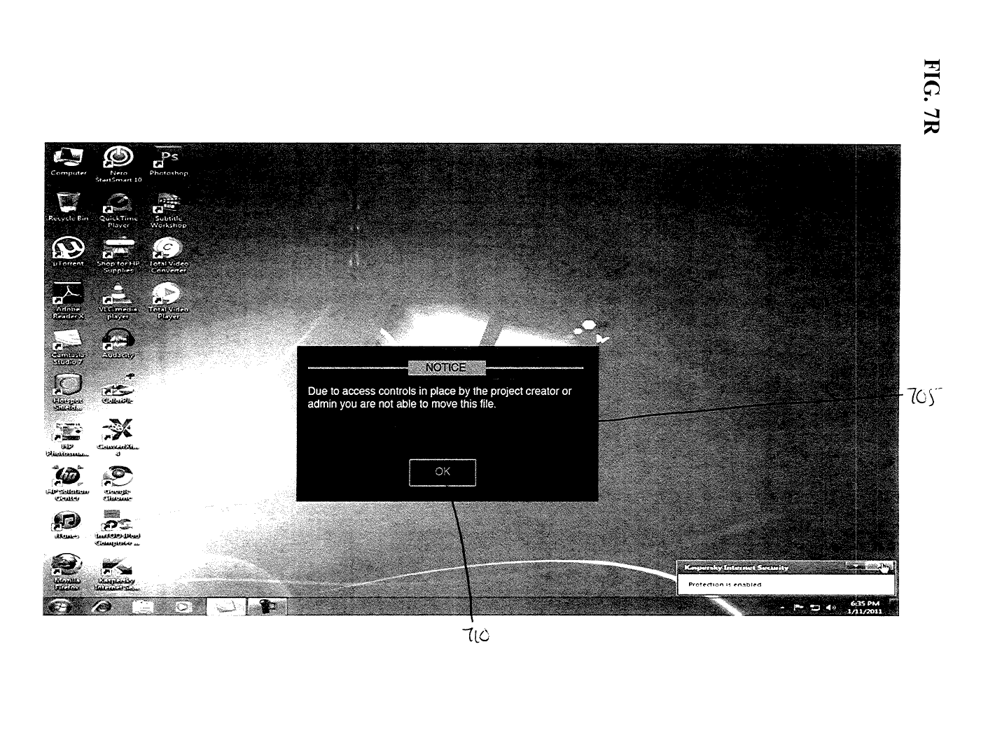

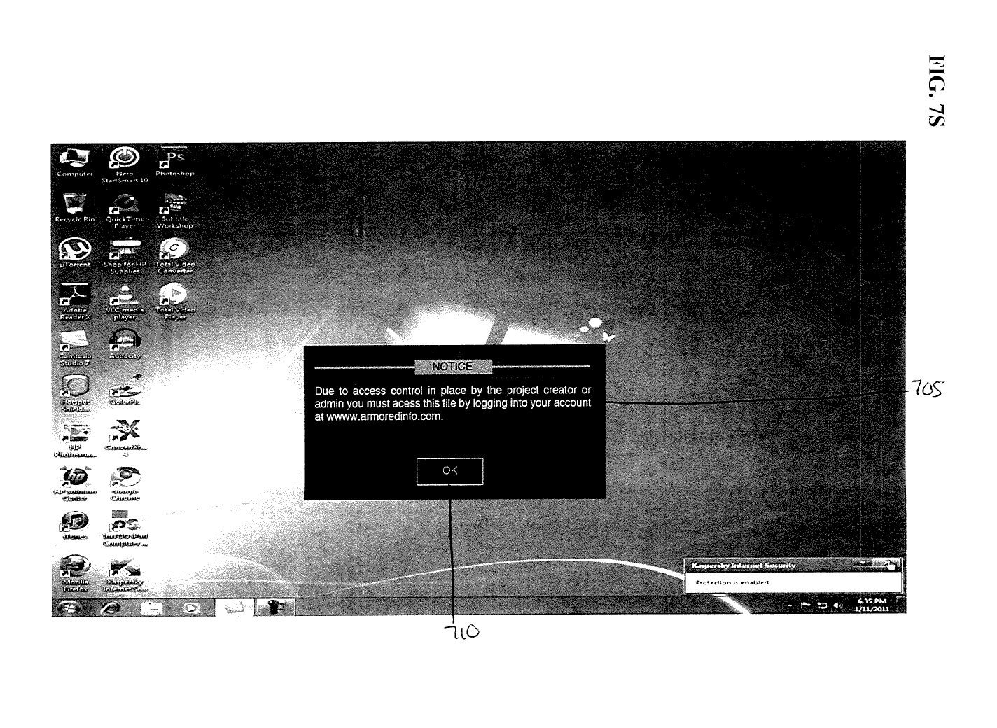

Referring now to FIG. 7A, the present invention is shown according a schematic illustration of the view users will see when they log into the sync application module for the first time. Upon signing in, users will be prompted to provide a username 705 and a password 710. Once the credentials have been inputted, a user will have the ability to log in 715. Logging in will authenticate the user. Once authenticated, media library and projects are synchronized with the encrypted local folder. If the wishers to log out of the application, selecting the X button 720 will close the sync application.

2FA—Two Factor Authentication applies and if it is an unrecognized location then the user will be prompted with 2FA—Two Factor Authentication view.

Referring now to FIG. 7B, there is shown a schematic illustration of a graphical user interface managing account security. In the exemplary shown, if a user enters too many password attempts the user will receive notification that the account has been locked due to failed login attempts 700. Further, the notification will prompt the user to log in through the desktop web view in order to go through the login password process. The user will also be able to close the sync application by hovering over and selecting the X button 720.

Referring now to FIG. 7C, there is shown a schematic illustration of the view users on a MacBook will see when they click the access logo (in this case labeled Armored Info) from their taskbar. The sync history 700 is responsible for tracking the time and date of the last sync. A progress bar 705 displays a progress of a user's request for synchronization. Users will also be able to upload actions for users and team members of any project(s) the user may be a part of In the exemplary shown, the user can view the following files: “Intro Song.mp3” “IBIZAVaca.jpg” and “Contract.docx” 710. Further, this also displays if someone has downloaded in those scenarios as well as deletes in one of those scenarios. Lastly, this also displays if someone accesses a project the user is a creator or admin of.

Referring now to FIG. 7D, there is shown schematic illustration of what the sync application will show up as on a Mac OS. The sync application will also show up as a folder 700. Within the folder 700 there will be two folders, one titled Media Library 705, and the other Projects 710. Media Library 705 will contain a user's assets and Projects 710 contains folders titled after the user's Project Names.

Referring now to FIG. 7E, there is shown a schematic illustration of what the individual project folders 705 within the main Projects folder 710 will look like. The project folders will list the name of the creator in the line item. Further, the date of last modification will be displayed.

Referring now to FIG. 7F, there is shown a schematic illustration of the sync icon. If a project or individual file is being synced, a black dot pulse 700 in the lower right corner will be displayed.

Referring now to FIG. 7G, there is shown a schematic illustration of what the sync progress will look like. A progress bar will be shown next to the project or individual file showing the progress of the sync 505. In the exemplary shown, the sync progress of “Master Recordings” is shown to be at 12%. In addition, if a project or file is not currently being synchronized it will say queued. In the exemplary illustration, “Design Drafts’ and “Architecture Plans” is shown to be queued.

Referring now to FIG. 7H, there is shown a schematic illustration of the display the user views when they are viewing the sync history 700. If a project or individual file is syncing, then syncing will display the loading logo 705.

Referring now to FIG. 7I, there is shown a schematic illustration of the view users on a Windows will see when they click the logo from their taskbar. Users are able to view the history of the last actions 700. Users will be able to see the progress of any file or project that is being synced 705. Users will also be able to upload actions for users and team members of any project(s) the user may be a part of 710. In the exemplary shown, the user can view the following files: “Intro Song.mp3” “IBIZAVaca.jpg” and “Contract.docx.” Further, this also displays if someone has downloaded in those scenarios as well as deletes in one of those scenarios. Lastly, this also displays if someone accesses a project the user is a creator or admin of.

Referring now to FIG. 7J, there is shown a schematic illustration of what the sync application module will show up as on a Windows. Similar to the sync application module on a MacBook, the sync application module on Windows will also show up as a folder 700. Within the folder 700 there will be two folders, one titled Media Library 705, and the other Projects 710. Media Library 705 will contain a user's assets and Projects 710 contains folders titled after the user's Project Names. In the exemplary shown, the user has a created a folder titled “Columbia.”

Referring now to FIG. 7K, there is shown a schematic illustration of the settings preferences 700. This view is shown by default when preferences are selected. A user will have access to general settings 705 and sync settings 710. The general settings include options for the following: 1) show desktop notifications 715, 2) sync iTunes content automatically 720, 3) start AI sync on system startup 725, and 4) pause sync 730. Start AI sync on system startup 725 is checked by default. This option starts that app on startup. In addition, show desktop notifications 715 is also checked by default. This displays notifications when the application is not open. Selecting Sync iTunes automatically 730 will add content from Music/iTunes/iTunesMedia/Music and Music/iTunes/iTunesMedia/Video to the users Media Library folder automatically. Hovering over and selecting the X button 735 will close settings.

Referring now to FIG. 7L, there is shown a schematic illustration of the view users see when they select the sync tab 710 from the settings preferences 700. The user has the option to select the browse button 705 or log out 710. Selecting the browse button allows users to personalize sync as shown in FIG. 7M. Logging out 710 logs the person out of their account and stops syncing. The user may also hover over and select the X button 715.

Referring now to FIG. 7M, there is shown a schematic illustration of the view users see when they are choosing personalized sync. Users will be able to check and uncheck which folders 705 to sync. Selecting a checkbox next to the folder indicates a user wants to sync that folder. Removing the checks indicates that the folders are not be synchronized. Selecting the OK button 710 will save changes and returns the user to the previous view. Selecting the cancel button 715 will not save the changes and returns the user to the previous view. Hovering over and selecting the X button 720.

Referring now to FIG. 7N, there is shown a schematic illustration of graphical user interface prompting for user input. In the exemplary illustration, a user is asked to confirm a password when the user attempts to move a file outside of the encrypted folder after fifteen minutes of folder inactivity 705. A user will also be prompted for password confirmation if they are attempting to move a project to a different location. Selecting the OK button 710 will authenticate the password. If a user enters the wrong password, the text field outline is highlighted red and the file or folder is prevented from being moved. Hovering over and selecting the X button 715 will close the dialog box and does not allow the file or folder to be moved.

Referring now to FIG. 70, there is shown a schematic illustration of a graphical user interface prompting for user input. In the exemplary illustration, a user receives notification that there is not enough storage available in the account to complete sync 705. The user is directed to the desktop web view and upgrade to a higher tier account 705. Selecting the OK button 710 will close the notice.

Referring now to FIG. 7P, there is shown a schematic illustration of a graphical user interface prompting for user input. In the exemplary illustration, a user receives notification that there is not enough storage available on the user's hard drive to sync the files and folders in their account 705. Selecting the OK button 710 will close the notice.

Referring now to FIG. 7Q, there is shown a schematic illustration of a graphical user interface prompting for user input. In the exemplary illustration, a user receives notification that they are logged out of their sync application and must log in to their account to move files or folders from the encrypted folder 705. Selecting the OK button 710 will close the notice.

Referring now to FIG. 7R, there is shown a schematic illustration of a graphical user interface prompting for user input. In the exemplary illustration, a user receives notification that they do not have permission to move file or folders from a project folder 705. Selecting the OK button 710 will close the notice.

Referring now to FIG. 7S, there is shown a schematic illustration of a graphical user interface prompting for user input. In the exemplary illustration, a user receives notification that they do not have permission to view a file from a project folder 705. The file is not actually downloaded and stored locally on the machine if the user only has view-only permission. Selecting the OK button will close the notice 710.

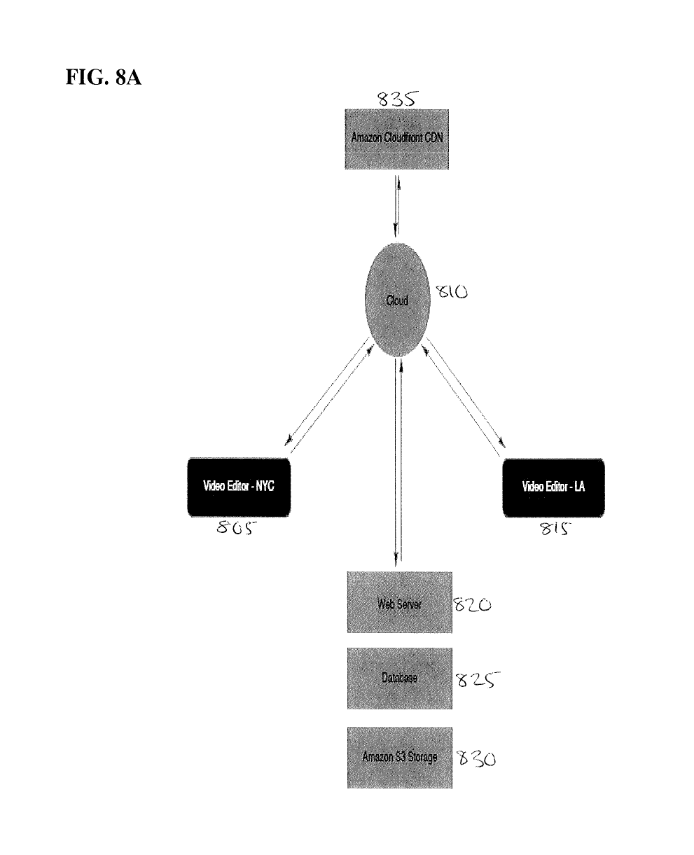

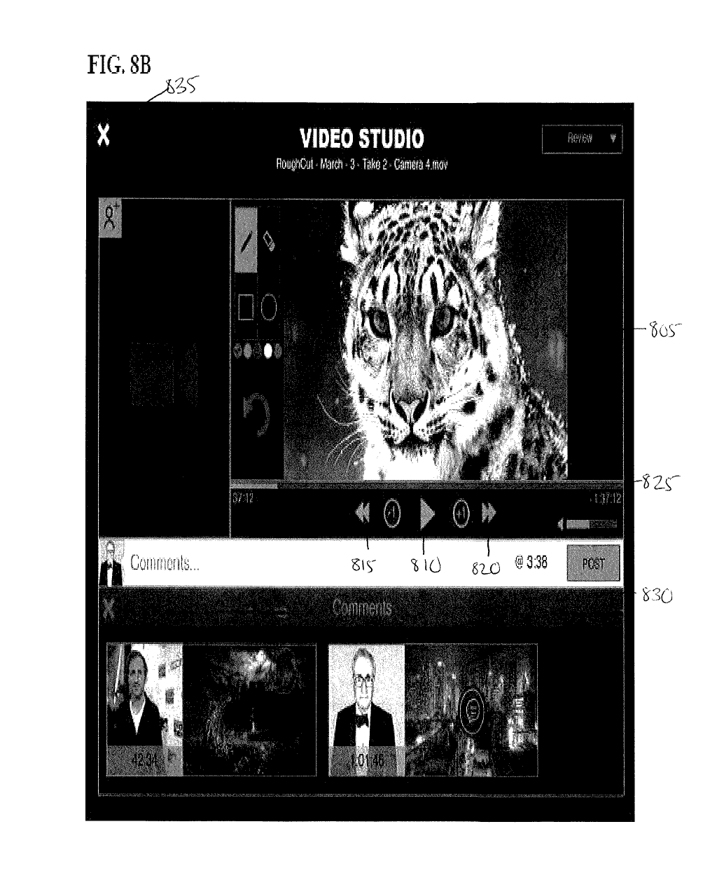

Referring now to FIG. 8A, there is shown a schematic illustration of simultaneous video collaboration. In the example shown, a user, a video editor in New York City 805, uploads a file to the cloud 810 and is able to simultaneously collaborate with a video editor in Los Angeles 815. Collaboration is real time and both contributors have access to the same audio file. This is possible because collaboration is happening through the web server 820, not locally on a user's device. After being transferred to the web server 820, the audio file is then transferred to the database 825 and then Amazon S3 Storage 830. The video editor in Los Angeles 815 is able to make changes and provide comments to the same video file. This real-time collaboration occurs without either party traveling, emailing, or requiring the same recording software. For example, this can all be done without the user having to constantly download the video file locally, open it in a DAW such as ProTools/Logic, make revisions, create a new bounce, and re-upload it to an unsecure cloud storage service or send a copy via email. The third-party content delivery network, e.g. Amazon's CloudFront CDN 835, is configured for receipt and storage of content received from multiple devices. In addition, the content delivery network is configured to be accessible by one or more viewer computing devices as required.

Referring now to FIG. 8B, there is shown a schematic illustration of a graphical user interface 800, which is the view the user sees when they click on the video studio icon in list view. The graphical user interface 800 displays the video 805B the user is working on. The graphical user interface 800 provides basic playback functions such as play/pause 810, rewind 815 (will rewind five seconds), and fast forward 820 (will fast forward five seconds). Alternatively, the user may access any point of time within the video file with the use of a slider 825. By dragging the slider 825 to a desired location along the video display 805, the user is thereby able to access the recording at that fragment of the video file. The user can also highlight a section of the slider 825 to loop that particular section of the video file. The video display 805 may provide visual clues to assist the user when selecting a starting point within the audio file. in addition to these basic playback functions, the user can submit comments about portions of the video file 830B. Hovering over and selecting the X button 835 will close the video studio.

It will be apparent to one of skill in the art that described herein is a novel system and method for simultaneous audio collaboration where remotely located users can provide annotations and comments on a secure environment. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. A system for real time media collaboration between at least two users operating the same electronically connected software application in remote locations, the system comprising:
at least one secure database running the software application, the at least one secure database interconnected to a network having access to a public or private internet connection, the software application including a first set of instructions to provide access to a media file simultaneously to each of at least two users, such that one user of the at least two users may modify said media file in a real time collaborative environment simultaneously with the other user of the at least two users;
a graphical user interface (GUI) displaying said application where the GUI is interconnected to the at least one secure database where said media file is stored on a real time basis as each of the at least two users modify said media file simultaneously; and
the application having simultaneous accessibility for the at least two users where each of the at least two users may manipulate said media file in real time and in a secure manner.

2. The system according to claim 1 further comprising a security module structured and arranged to determine the location of each of at least two users in order to selectively restrict access to said media file based upon said location.

3. The system according to claim 1 further comprising a content delivery network module interconnected to the GUI and the secure database and being the structured and arranged for receipt and storage of said media file received from multiple application software access points.

4. The system according to claim 1 further comprising an encryption module interconnected to the database and the GUI, said encryption module structured and arranged to provide secure point to point encryption between the at least two users.

5. The system according to claim 1 further comprising a synchronization application module interconnected to the GUI and the least one secure database, the synchronization application module structured and arranged to synchronize modifications of said file.

6. The system according to claim 1 where said media files include pre-recorded audio signals.

7. The system according to claim 6 where said media files include pre-recorded video signals.

8. The system according to claim 2 where the security module includes a global position system.

9. A computer apparatus consisting of a computer storage medium, a database, a central processor and a gui electrically interconnected, where the computer storage medium contains computer software having instructions to:
provide access to a media file simultaneously to each of at least two users, such that one user of the at least two users may modify said media file in a real time collaborative environment simultaneously with the other user of the at least two users;
display said application to each user, where the GUI is interconnected to the at least one secure database where said media file is stored on a real time basis as each of the at least two users modify said media file simultaneously; and
provide simultaneous access to said application such that each of the at least two may manipulate said media file in real time and in a secure manner.

10. The apparatus according to claim 9 further comprising instructions to determine the location of each of at least two users in order to selectively restrict access to said media file based upon said location.

11. The apparatus according to claim 10 further comprising instructions for receipt and storage of said media file received from multiple application software access points.

12. The apparatus according to claim 11 further comprising instructions to provide secure point to point encryption between the at least two users.

13. The apparatus according to claim 12 further comprising instructions to provide instructions to synchronize modifications of said file.

14. The apparatus according to claim 13 where said media files include pre-recorded audio signals.

15. The apparatus according to claim 13 where said media files include pre-recorded video signals.

16. The apparatus according to claim 13 further comprising instructions to implement a global position system.
